(19) United States
(12) Patent Application Publication
(10) Pub. No.: US 2024/0104515 A1
(43) Pub. Date: Mar. 28, 2024

(54) DEVICE AND METHOD FOR INSPECTING AN INDUSTRIAL VEHICLE

(71) Applicant: KIWITRON S.R.L., Sasso Marconi (Bologna) (IT)

(72) Inventors: Carlo PETRELLI, Sala Bolognese (Bolognese) (IT); Daniele PARAZZA, Montese (Modena) (IT); Andrea FILIPPINI, Sasso Marconi (Bologna) (IT); Federico FRONTALI, Imola (Bologna) (IT)

(21) Appl. No.: 18/263,858

(22) PCT Filed: Feb. 3, 2022
(86) PCT No.: PCT/IB2022/050949

§ 371 Date: Aug. 1, 2023

(30) Foreign Application Priority Data
Feb. 3, 2021 (IT) 102021000002297
Feb. 3, 2021 (IT) 102021000002309

(51) Int. Cl. G06Q 10/20; B25J 9/16; G05D 1/224; G06T 7/00; G06T 7/60

(52) U.S. Cl. CPC G06Q 10/20; B25J 9/1697; G05D 1/2247; G06T 7/0004; G06T 7/60; G05D 2105/89; G06T 2200/24; G06T 2207/10016; G06T 2207/10032; G06T 2207/30164; G06T 2207/30252

(57) ABSTRACT

Method for inspecting an industrial equipment in an operating space, including the following steps: receiving image data, detected by a measurement device and representing an image including at least one component of the industrial equipment; processing the image data by means of machine vision algorithms to identify a control parameter; processing image data and determining a dimensional measurement, using machine vision algorithms, corresponding to the control parameter identified; formulating and sending a read request to a memory, based on the control parameter identified; sending an allowable maintenance value, representing an allowable value of the control parameter identified; comparing between the allowable maintenance value and the dimensional measurement; generating a diagnosis, based on the comparison between the allowable maintenance value and the dimensional measurement.

### TECHNICAL FIELD

This invention relates to a system for inspecting and/or checking the wear of an industrial equipment, in particular lifting cages, conveyor carriages, AGV carriages or any other industrial equipment which, during its service life, require maintenance activities.

### BACKGROUND ART

In the sector of devices for controlling and inspecting industrial equipment there are prior art systems which, with the substantial support of a maintenance user, are used to take significant measurements of the mechanical elements. In particular, there are prior art dimensional measurement instruments which, located close to the mechanical element to be inspected, allow the dimensions of the object to be measured. Subsequently, the maintenance user, on the basis of said measurements, is able to determine the need, or not, to replace the component or whether, on the other hand, it is possible to continue safely with the use of the equipment. These inspections, being particularly linked to human intervention, are onerous and cannot be performed with a very high frequency. For this reason, since the wear may also have trends which cannot always be forecast, it is possible that the conditions of the equipment are not safe between one inspection and the next, placing at risk the workers and the objects involved. Lastly, another drawback derives from the fact that some mechanical elements subject to wear are located on the lower platform of the equipment and their accessibility requires the lifting of the equipment.

### AIM OF THE INVENTION

The aim of the invention is to provide a system for inspecting an industrial equipment and an inspection method which overcome the above-mentioned drawbacks of the prior art.

Said aim is fully achieved by the system and by the method according to the invention as characterised in the appended claims.

According to an aspect of the invention, the invention provides a system for inspecting an industrial equipment.

The system comprises a measurement apparatus.

The measurement apparatus comprises an inspection zone. The inspection zone is configured to house the industrial equipment in a predetermined inspection location.

The measurement apparatus comprises a measurement device. The measurement device is configured for detecting measurement data, representing dimensional measurements performed on the industrial equipment. Preferably, the measurement data represents a dimensional value such as a length, an extension, a diameter, a distance between two elements, a thickness. The measurement device is configured for detecting parameter data, each associated with a corresponding measurement data. Each parameter data represents a respective parameter of the industrial equipment to which the measurement data refers. It should be noted that, according to an embodiment, the measurement data and the parameter data are the same data which, processed in a different manner, provide information regarding the parameter and the dimensional measurements associated with it. For example, but without limiting the scope of the invention, a 2D or 3D photo may determine both a dimensional value and the parameter to which the dimensional value refers.

It should be noted that, on the basis of the measurement data, the control unit is also programmed to identify logic values of a parameter, for example a true or false value, which refers to the status of a predetermined parameter. For example, but without limiting the scope of the invention, the parameter identified by the parameter data could be the presence of rust in the chains, whilst the value identified could be true (presence of escape) or false (absence of rust).

For this reason, according to an embodiment, the measurement device according to the system measures image data, representing dimensional measurements taken on the industrial equipment and representing a respective parameter of the industrial equipment to which the dimensional measurement refers.

The measurement apparatus comprises a handling device, configured for moving the measurement device around the industrial equipment.

The system comprises a memory. Preferably, the memory comprises, for each parameter of the industrial equipment, a corresponding limit maintenance value.

Preferably, the limit maintenance value is a dimensional value such as a length, an extension, a diameter, a distance between two elements, a thickness.

The system comprises a control unit, programmed for receiving the measurement data and/or the parameter data. According to a preferred embodiment, the control unit is programmed for identifying, for each parameter data, the corresponding parameter of the industrial equipment.

It should be noted that this step requires that the control unit is able, automatically, by means of, for example, image recognition algorithms, to identify the parameter of the industrial equipment even in the absence of a specification by the operator regarding the parameter under control. For this reason, in other words, when the device is directed towards the equipment, the latter recognises the particular element and identifies which parameter is to be measured and then compares it with the maintenance limit values. This guarantees a considerable slenderness in the control operations which are reduced, substantially, only to capturing the industrial equipment and the resulting output. This is very important also in the case of automatic controls, that is to say, performed in the absence of a manual intervention which can set the parameter to be controlled.

The control unit is programmed for retrieving, for each parameter of the industrial equipment, the corresponding limit maintenance value.

The control unit is programmed for comparing, for each parameter of the industrial equipment, the corresponding limit maintenance value and the corresponding measurement data. According to an embodiment, the control unit is programmed to make a difference between the dimensional value determined by the measurement data and the limit maintenance value, to determine a difference between the two values. Subsequently, the control unit is programmed for comparing the difference between the two values with a predetermined limit deviation, in such a way as to alert the need for maintenance only for deviation values greater than the predetermined deviation.

The control unit is programmed to perform a diagnosis of the industrial equipment, on the basis of the comparison, for each parameter of the industrial equipment, between the corresponding limit maintenance value and the corresponding measurement data.

It should be noted that, according to an advantageous embodiment, compared with the prior art, which comprises comparing images, the method according to the invention comprises a numerical comparison between the limit maintenance value and the measurement data. This is very advantageous because it allows the control to be made less sensitive compared with a photo comparison which, for example, requires a uniformity between the reference photo and the photo captured. In this case, on the other hand, the numerical value is already made independent of the measurement conditions and, therefore, the control may also be performed in inspection zones different from each other.

This makes it possible to speed up inspection operations, make them more reliable and, above all, increase the frequency, preventing accelerated wear of the mechanical elements from adversely affecting the safety of persons and/or objects.

According to an embodiment, the measurement device comprises a two-dimensional video camera and/or a three-dimensional video camera.

According to an embodiment, the parameter data are image data, captured by the video camera.

Preferably, the control unit is programmed to identify the parameter of the equipment corresponding to the parameter data on the basis of image recognition algorithms.

The system, according to a preferred embodiment, comprises a remote server. The memory is housed in the remote server.

According to an embodiment, the control unit comprises a transmission unit and a processing unit. The transmission unit is configured for sending, by means of a signal transceiver, the measurement and/or localisation data to the processing unit. The processing unit is configured for processing the measurement data and the parameter data.

According to a preferred embodiment, the transmission unit is installed on the measurement apparatus whilst the processing unit is installed on the remote server (remote processor).

The system comprises a user interface, preferably including a display unit. The control unit is programmed to show results of the diagnosis on the display. Preferably, the user interface comprises selection commands, by which the user can confirm or reject the diagnosis. This always makes it possible to carry out a final check by the maintenance user, but with decidedly less time than the prior art solutions.

According to an embodiment, the measurement apparatus comprises a handling device, configured to move the measurement apparatus inside an operating space in which the industrial equipment is used. In that way, the system also comprises moving towards the heavier industrial equipment or to the equipment which cannot be moved.

According to an embodiment, the measurement apparatus is a drone, which can be controlled preferably remotely inside the operating space. The drone is configured to fly over the industrial equipment, surrounding it in all its sides.

For this reason, according to this embodiment, any industrial equipment can be rapidly inspected.

According to an embodiment, the measurement device performs a contact measurement. In other words, the measurement data are determined by contact measurements. According to other embodiments, the measurement data are determined by contactless measurements and which use image detection.

According to an embodiment, the handling device comprises a robotic arm. The robotic arm is preferably movable by translating along three axes perpendicular to each other and rotatable about each of said three axes. However, there are also solutions wherein the robotic arm is translating along a single direction and/or rotates about a single axis, depending on the needs required by the industrial equipment.

According to an aspect of the invention, the parameters of the industrial equipment subject to the measurement can be selected from one or more of the following parameters:
wheel diameters;
thickness of the forks;
wear of the chains;

According to an aspect of the invention, the control unit is programmed for storing in the memory a log of the measurements, including a set of measurement data of each parameter for a same equipment. The control unit is programmed to determine, based on the log of measurements, a rate of wear.

The control unit is configured to program one or more preventive maintenance interventions based on the rate of wear.

These features are very important in order to avoid accidents and to put into safety the industrial equipment, since it makes it possible to forecast, with a good degree of reliability due to the frequency of the inspections, the moment at which it will be necessary to replace the mechanical unit or the component. For this reason, by providing a suitable safety coefficient, the probability of inspecting industrial equipment which is outside the allowable safety ranges is considerably reduced.

According to an embodiment, the control unit is programmed to determine the control parameter and the dimensional values on the basis of computer vision algorithms. In order to determine the dimensional values by means of computer vision algorithms, the control unit is programmed to be calibrated, that is to say, to receive a dimensional value by means of pixels measured by the measurement device. This then makes it possible to identify predetermined objects and be able to associate them to a real dimension. Libraries commonly known to experts in the field can be used for the determination of the dimensions, such as, for example, OpenCV.

The computer vision algorithms used include image classification, object detection, semantic segmentation, instance segmentation.

According to an aspect of the invention, the invention provides a method for inspecting an industrial equipment.

The method comprises a step of positioning the industrial equipment in a predetermined inspection location inside an inspection zone of a measurement apparatus.

The method comprises a step of measuring measurement data, representing dimensional measurements performed on the industrial equipment.

The method comprises a step of detecting parameter data, each associated with a corresponding measurement data and representing a respective parameter of the industrial equipment to which the measurement data relates.

The method comprises a step of moving the measurement device around the industrial equipment.

The method comprises a step of receiving measurement data and/or parameter data in a control unit.

The method comprises a step of identifying, for each parameter data, the corresponding parameter of the industrial equipment.

The method comprises a step of recovering, for each parameter of the industrial equipment, a corresponding limit maintenance value.

The method comprises a step of comparing, for each parameter of the industrial equipment, between the corresponding limit maintenance value and the corresponding measurement data.

The method comprises a step of diagnosis of the industrial equipment, on the basis of the comparison, for each parameter of the industrial equipment, between the corresponding limit maintenance value and the corresponding measurement data.

According to an aspect of the invention, the invention provides a method for inspecting an industrial equipment in an operating space.

The method comprises a step of receiving image data, detected by a measurement device. The image data are representative of an image including at least one component of the industrial equipment.

The method comprises a step of processing the image data by machine vision algorithms to identify a control parameter.

The method comprises a step of processing the measurement data. The method comprises a step of determining a dimensional measurement, by machine vision algorithms, corresponding to the identified control parameter.

The method comprises a step of formulating and sending a read request to a memory, based on the identified control parameter. In other words, the processor formulates a search interrogation and sends it to the memory for reading specific data.

The method comprises a step of sending an allowable maintenance value, representative of an allowable value of the identified control parameter. The sending is executed on the basis of the read request sent.

The method comprises a step of comparing the allowable maintenance value with the dimensional measurement.

The method comprises a step of generating a diagnosis, on the basis of the comparison between the allowable maintenance value and the dimensional measurement. The diagnosis may be an alarm signal, identifying the need to intervene and maintain the industrial equipment. Moreover, the diagnosis may include an authorisation signal, identifying the fact that the industrial equipment may still be used safely.

The method comprises a step of generating display data, representing a modified image. The modified image comprises the image obtained (received) by means of the image data and one or more geometrical elements. Said one or more geometrical elements represent heights and/or edges of the elements identified in the image. The method comprises a step of loading the display data on a display of a device, to show the modified image, preferably in real time.

According to an embodiment, the processor updates the display data with the variation of the image data, preferably in real time.

The method comprises an interaction step. The interaction step comprises a step of generating interaction data, representing one or more selection commands with which a user can interact. In other words, the display data are data which determines the creation on the display of one or more inputs (selection commands).

The interaction step comprises a step of loading the interaction data into a display unit of a device, to enable interaction with the user.

The interaction step comprises a step of receiving control data, entered by the user on the basis of the selected command.

The control data are representative of one or more of the listed steps to be performed by the processor:
saving the image data and/or the dimensional value calculated from the image data;
setting of the number of useful working hours remaining;
request for immediate maintenance intervention;
scheduling a preventive maintenance intervention.

According to an embodiment, the image data represent a distance between links of a chain of the industrial equipment, preferably adjacent to each other. According to an embodiment, the limit maintenance value includes a limit distance value between two successive links. According to an embodiment, the image data represent a total length of the chain of the industrial equipment, preferably adjacent to each other. According to an embodiment, the limit maintenance value includes a maximum length value of the chain.

The method comprises a step of receiving reference data, identifying a shape, a colour and/or an edge of a component of the industrial equipment.

The method comprises a step of identifying the control parameter on the basis of the reference data.

The method comprises a step of receiving confirmation data, entered by a user to confirm or reject an identification of the control parameter performed by the processor. The processor updates the reference data on the basis of the confirmation data, in such a way as to progressively reduce the error in identifying the control parameter.

According to an aspect of the invention, the invention provides a device for inspecting an industrial equipment.

The device comprises a processor, configured to perform the steps of the method for inspecting the industrial equipment described in the invention.

The device comprises a memory, including allowable maintenance values. The device comprises a display, configured to show a diagnosis of the industrial equipment. The device comprises one or more selection commands, configured to allow the entering of control data by a maintenance user. The device comprises a measurement device, configured to capture image data, representative of an image including at least one component of the industrial equipment. The measurement device may be an RGB or 3D video camera.

The device comprises a wireless connection. The device is configured for transmitting the image data to a remote server, including a remote memory.

Preferably, the device is a mobile device, which can be carried by a maintenance user, for example a smartphone or a tablet.

According to an aspect of the invention, the invention provides a computer program including instructions for performing the method for inspecting an industrial equipment according to the invention.

### BRIEF DESCRIPTION OF THE DRAWINGS

These and other features of the invention will become more apparent from the following detailed description of a preferred, non-limiting embodiment of it, with reference to the accompanying drawings, in which:

FIG. 1 schematically illustrates an embodiment of a system for inspecting an industrial equipment;

FIGS. 2A, 2B and 2C schematically illustrate a first, a second and a third embodiment of a measurement apparatus of the system of FIG. 1;

FIGS. 3A and 3B illustrate a first and a second screen of a device for inspecting an industrial equipment.

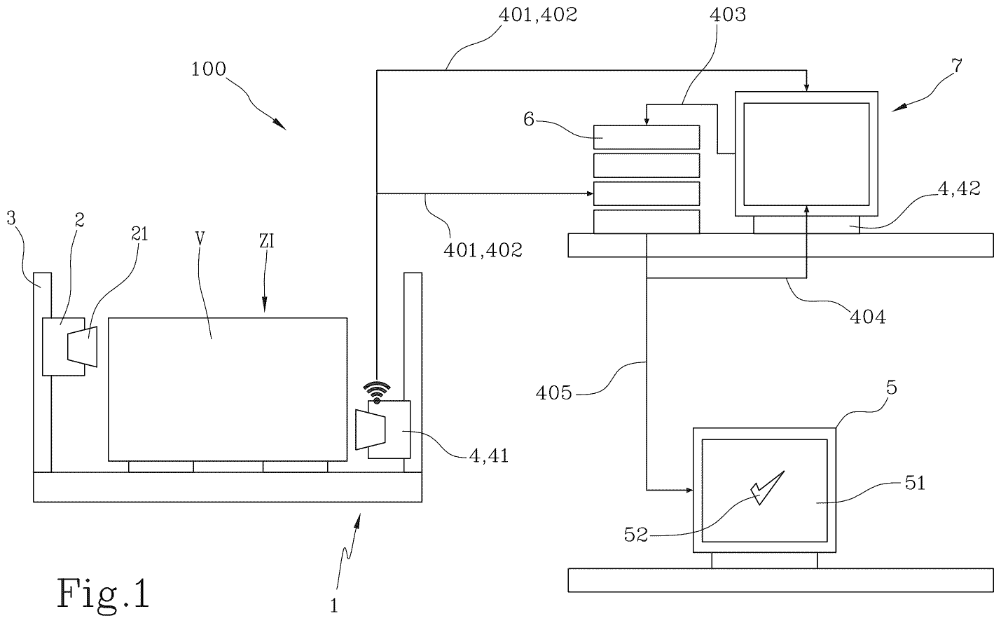

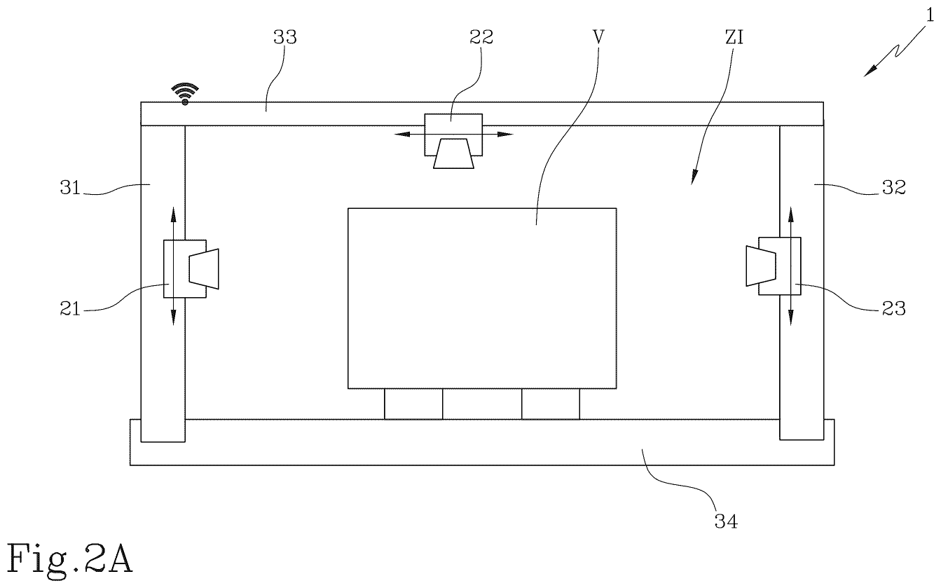

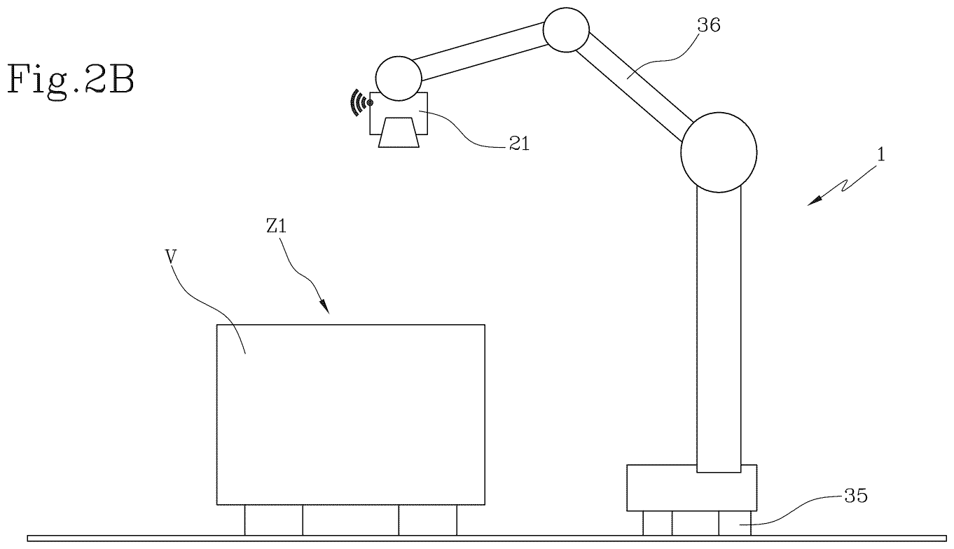

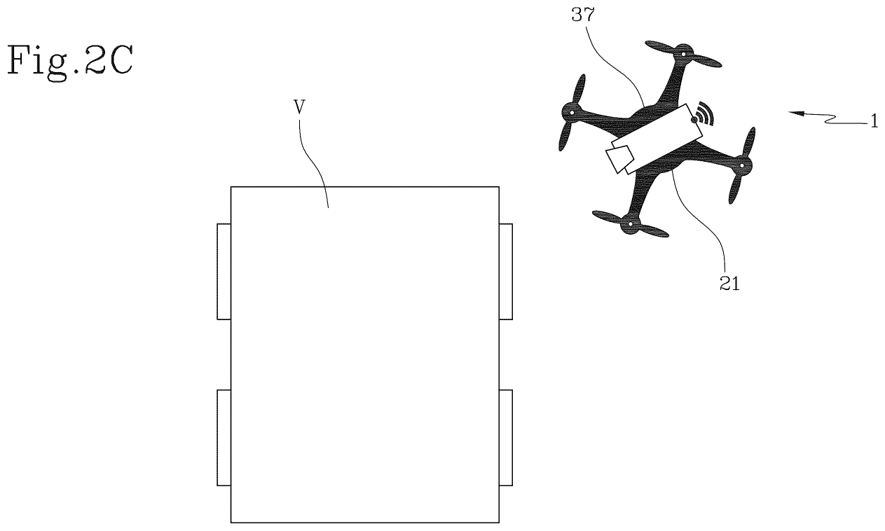

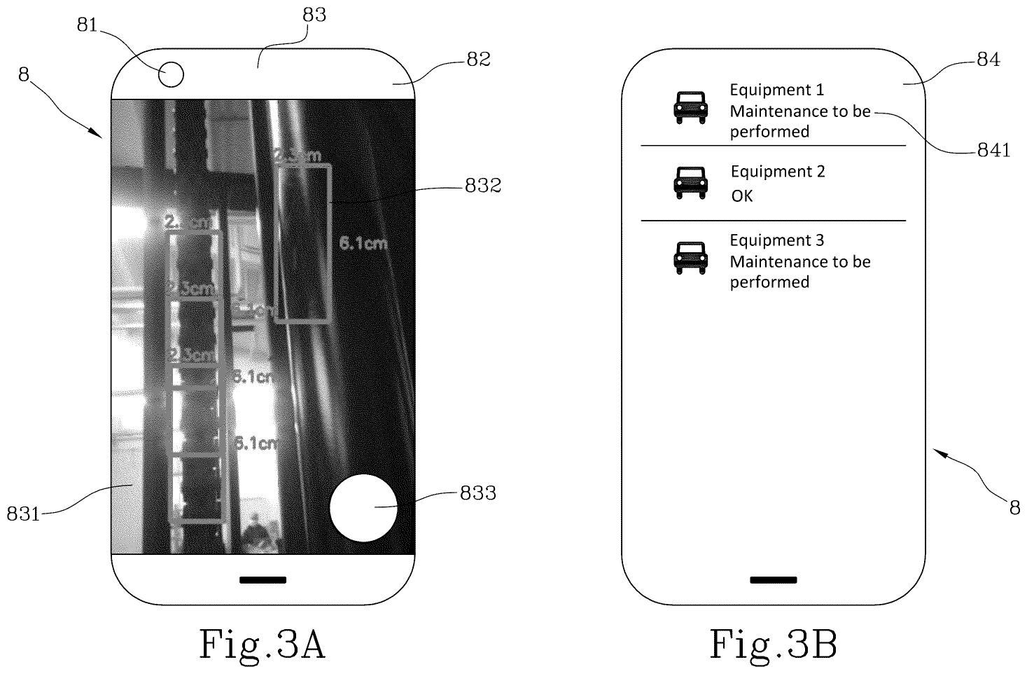

### DETAILED DESCRIPTION OF PREFERRED EMBODIMENTS OF THE INVENTION

With reference to the accompanying drawings, the numeral 100 denotes a system for inspecting and/or controlling an industrial equipment, for example an industrial vehicle V movable in an operating space. The industrial equipment V may also be fixed in the operating space.

The system 100 comprises a measurement apparatus 1. The measurement apparatus 1 is configured for detecting data and measurements relative to the industrial equipment V. The industrial equipment V is configured to be located in a predetermined position inside an inspection zone ZI of the measurement apparatus 1.

In particular, the measurement apparatus 1 comprises a measurement device 2, configured for detecting data 401, representing dimensional measurements of the equipment V, for example the thickness of a component, the diameter of a wheel. The measurement device 2 is configured for detecting parameter data 402, for identifying the physical parameter to which the measurement data 401 refers. According to a preferred embodiment, the measurement device 2 comprises a first video camera 21, configured for determining image data, which define the measurement data and the parameter data, since, from different processing of the same image data it is possible to determine the dimensional measurements and the parameter to which they refer with suitable processing algorithms.

According to an embodiment, the measurement device comprises a second video camera 22 and/or a third video camera 23. Each of said first, second and third video cameras 21, 22, 23 may be RGB, 2D, 3D video cameras. Each of said first, second and third video cameras 21, 22, 23 detects respective image data, including the corresponding measurement data 401 and the parameter data 402.

The measurement apparatus 1 comprises a handling device 3, which is configured to allow a movement of the measurement device 2 around the equipment V.

According to an aspect of the invention, three embodiments of the handling device 3 are indicated, which can be implemented in different methods and which correspond to inspection requirements which are different to each other.

According to a first embodiment, preferably used to inspect equipment V which are movable and easily movable, the handling device 3 comprises a first column 31, a second column 32, a crosspiece 33 and a base 34. The equipment V is supported on the base 34, which comprises, for example, a platform.

The first video camera 21 is associated (connected) with the first column 31. The second video camera 22 is associated (connected) with the second column 32a. The third video camera 23 is associated (connected) with the crosspiece 33.

The first and second columns 31, 32 and the crosspiece 33 are slidable along guides positioned on the base 34, in such a way as to move along a first direction. The crosspiece 33 is movable vertically relative to the first and second columns 31, 32 in such a way as to move the third video camera 23 towards and away from the equipment V.

The first video camera 21 is movable vertically along the first column 31. The second video camera 22 is movable vertically along the second column 32. The third video camera is movable along the crosspiece in a second direction perpendicular to the first column and to the first direction. In this way, each part of the equipment V can be inspected.

According to an embodiment, the base 34 includes one or more additional video cameras, if necessary infrared, for detecting data from the lower platform of the equipment V.

According to a second embodiment of the measurement apparatus, the handling device 3 comprises a movable platform, which includes one or more moving rolling elements 35. This allows the measurement apparatus 1 to move in the operating space to move close to equipment V which are fixed or very heavy and therefore difficult to move. Nothing prevents the implementation of the rolling elements 35 in the base 34 illustrated in the first embodiment.

According to this example, the handling device 3 comprises a robotic arm 36, including one or more joints and one or more segments, connected to each other by means of the joints.

The first video camera 21 is connected to a first end of the robotic arm 36 whilst the second end of the robotic arm is connected to a column which rises from the movable platform 35.

The degrees of freedom of the robotic arm 35 allow substantially any part of the equipment V to be inspected.

Lastly, according to a third embodiment, the movement device 1 comprises a drone 37, equipped with one or more propellers which allow a total freedom of encircling the equipment V and, therefore, a precision in detecting the measurement data 401 and very precise localisation 402.

According to an embodiment, the system 100 comprises a control unit 4. The control unit 4 is programmed to process the measurement data 401 and the parameter data 402.

The control unit 4, according to an embodiment, may be located inside the measurement apparatus entirely, whilst, according to a further embodiment, it may be divided into various units, located in different positions and communicating with each other.

In particular, according to a preferred embodiment, the control unit 4 comprises a transmission unit 41. Moreover, the control unit 4 comprises a processing unit 42. Preferably, the system 100 comprises a remote server 7, for example a cloud server having a processing capacity and a memory capacity.

According to an embodiment, the transmission unit 41 and the processing unit 42 are both located in the measurement apparatus 1.

The transmission unit 41 is configured for transmitting the measurement data 401 and/or the parameter data 402.

According to other embodiments, on the other hand, the transmission unit 41 is located in the measurement apparatus 1 whilst the processing unit 42 is defined by a dedicated processor in the remote server 7. According to this embodiment, the transmission unit 41 is programmed for sending the measurement data 401 and the parameter data 402 to the processing unit 42.

According to an embodiment, the system 100 comprises a memory 6. The memory 6 is preferably located in the remote server 7. However, the memory 6 can also be provided directly on the measurement apparatus 1 (local memory).

According to an embodiment, the transmission unit 41 is configured for sending the measurement data 401 and/or the parameter data 402 to the memory 6 for maintaining a log of the measurements over time.

According to an embodiment, the control unit 4 is programmed for identifying, for each of said parameter data, a corresponding (control) parameter 403. The control parameter 403 is a physical parameter which relates to the industrial equipment, such as, for example, length of the chain, diameter of the wheels. According to an embodiment, the control unit 4 is programmed to identify, for each of said parameter data 402, a corresponding dimensional value measured, on the basis of the measurement data 401 associated with the parameter data 402. In short, the control unit 4 determines, for example, the measured value of the deformation of the chain.

According to an embodiment, the control unit 4 is programmed for recovering limit maintenance values 404, each associated with a corresponding (control) parameter 403. The limit maintenance value 404 represents a limit value beyond which it is necessary to provide for the maintenance of the mechanical element to which the parameter refers. In other words, the limit maintenance value 404 for a chain could be the maximum allowable deformation, which refers to the deformation parameter of the chain.

The control unit 4 is programmed to compare, for each control parameter 403, the measured dimensional value with the limit maintenance value 404. On the basis of said comparison, the control unit 4 is programmed to emit a diagnosis 405 of the mechanical element corresponding to each control parameter 403.

According to an embodiment, the system 100 comprises a user interface 5. The user interface comprises a display 51. The user interface 5 is connected to the control unit 4 (to the transmission unit 41 and/or to the processing unit 42).

The user interface 5 is connected to the control unit 4 for receiving the diagnosis 405 and displaying it on the display 51.

According to an embodiment, the control unit 4 is programmed to show on the display 51 of the user interface also the log of the measurements, from which it is possible to determine a trend of the control parameter 403 over time. Based on said trend, the user can program a preventive maintenance intervention. According to other embodiments, the control unit 4 is programmed to schedule a preventive maintenance intervention, on the basis of each log of the measurements of the control parameters 403 and of the corresponding allowable maintenance value 404.

The user interface 5 comprises one or more selection commands 52. Said one or more selection commands allow one or more of the following manual activities to be performed by a maintenance user:
confirming the diagnosis 405 received;
rejecting the diagnosis 405 for errors identified performed by the control unit, for example in determining the control parameter 403 and/or in determining the dimensional value;
setting a number of remaining useful working hours with reference to the mechanical element, on the basis of the diagnosis 405 received. Said number of useful working hours are saved in the memory 6. The control unit 4 is programmed to alert the user when the working hours exceed the number of remaining useful working hours;
directly programming a maintenance intervention on the industrial equipment;
confirming the scheduling of the preventive maintenance intervention.

According to an embodiment, the user interface 5 could be located in the remote server 7, on the measurement apparatus 1 or on a remote terminal relative to the server 7 and the apparatus 1, for example a monitoring computer, a tablet or a smartphone.

According to an example shown purely by way of example, the system 100 allows the chains to be controlled in industrial equipment, for example a lift truck or a lift cage.

The periodic control of the chains concerns the identification of three control parameters:
presence of rust on the chains, caused by an incorrect or insufficient lubrication;
protrusion of the pins, also generated by insufficient or incorrect lubrication;
wear of the chains and presence of cracked links, which, unless it is the result of a sudden breakage due to an operator error, impact load or overload, is normally a gradual process in which the chain lengthens whilst it wears.

According to an embodiment, the user interface 5 is located in the measurement apparatus which, in this case, is a mobile electronic device, such as a smartphone 8.

The smartphone 8 comprises a video camera 81 and a display 82.

The device 8 is programmed to show on the display 82 a first operating module 83.

The first operating module 83 comprises an image block 831, on which are shown image data captured by the video camera 81. On the image block 831 one or more geometrical elements 832 are also shown, representing dimensions and edges of the elements identified in the image.

The first operating module also comprises a maintenance request button 833. The processor of the device 8 is programmed to send a maintenance request in response to the selection of the maintenance request button 833.

The device 8 is programmed to show on the display 82 a second operating module 84. The second operating module 84 includes a list 841 of industrial equipment, each of which is associated with information regarding the need, or not, to maintain the industrial equipment.

The device 8 is programmed to show on the display 82 a third operating module. The third operating module represents the log of the dimensional values of each control parameter measured for a specific industrial equipment selected in the second operating module 84.

The following paragraphs, listed with alphanumeric references, are non-limiting example methods of describing the invention.

A00. A system 100 for inspecting an industrial equipment V, comprising:
a measurement apparatus 1 including:
an inspection zone ZI, configured to house the industrial equipment at a predetermined inspection location;
a measurement device 2, configured for detecting measurement data 401, representative of measurements performed on the industrial equipment, and parameter data 402, each associated with a corresponding measurement data 401 and representative of a respective parameter 403 of the industrial equipment to which the measurement data 401 relates;
a handling device 3, configured for moving the measurement device 2 around the industrial equipment V;
a memory 6, including, for each parameter of the industrial equipment V, a corresponding limit maintenance value 404;
a control unit 4, programmed for receiving the measurement data 401 and the parameter data 402, characterised in that the control unit 4 is programmed for:
identifying, for each parameter data 403, the corresponding parameter of the industrial equipment V;
retrieving, for each parameter 403 of the industrial equipment V, the corresponding limit maintenance value;
comparing, for each parameter 403 of the industrial equipment V, the corresponding limit maintenance value 404 and the corresponding measurement data 401;
performing a diagnosis 405 of the industrial equipment V, based on the comparison, for each parameter 403 of the industrial equipment V, between the corresponding limit maintenance value 404 and the corresponding measurement data 401.

A0. The system 100 according to paragraph A00, wherein the measurement device 2 comprises a two-dimensional video camera or a three-dimensional video camera.

A1. The system 100 according to paragraph A0, wherein the parameter data 402 are image data, detected by the video camera and wherein the control unit 4 is programmed to identify the parameter 403 corresponding to the parameter data 402 based on image recognition algorithms.

A2. The system 100 according to any one of paragraphs A00 to A1, comprising a remote server 7, in which is allocated the memory 6 and wherein the control unit 4 comprises a transmission unit 41 and a processing unit 42, wherein the transmission unit 41 is associated with the measurement device 2 and is configured to send the measurement data 401 and the parameter data 402 to the processing unit 42, which resides on the remote server 7.

A3. The system 100 according to any one of paragraphs A00 to A2, comprising a user interface 5, including a display 51, and wherein the control unit 4 is programmed to show diagnosis results 405 on the display 51, the user interface comprising selection commands, by which the user can confirm or reject the diagnosis 405.

A4. The system 100 according to any one of paragraphs A00 to A3, wherein the measurement apparatus 1 comprises a handling device 35, configured for moving the measurement apparatus 1 inside an operating space in which the industrial equipment is used.

A4.1. The system 100 according to paragraph A4, wherein the measurement apparatus 1 is a drone 37, which can be controlled remotely inside the operating space.

A5. The system 100 according to any one of paragraphs A00 to A4.1, wherein the measurement device 2 performs a contact measurement.

A6. The system 100 according to any one of paragraphs A00 to A5, wherein the handling device 35 comprises a robotic arm 36, movable by translation along three axes perpendicular to each other and rotating about each of said three axes.

A7. The system 100 according to any one of paragraphs A00 to A6, wherein the parameters 403 of the industrial equipment V subject to measurement can be selected from one or more of the following parameters:
wheel diameters;
thickness of the forks;
wear of the chains.

A8. The system 100 according to any one of paragraphs A00 to A7, wherein the control unit 4 is programmed for:
storing in the memory 6 a log of the measurements, including a set of measurement data of a parameter for a same equipment;
determining, on the basis of the log of the measurements, a rate of wear;
programming, on the basis of the rate of wear, one or more preventive maintenance interventions.

B00. A method for inspecting an industrial equipment V, the method comprising the following steps:
positioning the industrial equipment V at a predetermined inspection location inside an inspection zone ZI of a measurement apparatus 1;
measuring measurement data 401, representing dimensional measurements performed on the industrial equipment;
detecting parameter data 402, each associated with a corresponding measurement data 401 and representing a respective parameter 403 of the industrial equipment V to which the measurement data relates;
moving the measurement device 2 around the industrial equipment;
receiving measurement data 401 and parameter data 402 in a control unit 4;
identifying, for each parameter data 403, the corresponding parameter of the industrial equipment;
recovering, for each parameter of the industrial equipment, a corresponding limit maintenance value 404;
comparing, for each parameter of the industrial equipment, between the corresponding limit maintenance value 404 and the corresponding measurement data 401;
diagnosing 405 the industrial equipment, on the basis of the comparison, for each parameter of the industrial equipment, between the corresponding limit maintenance value 404 and the corresponding measurement data 401.

What is claimed:

1. A method for inspecting an industrial equipment in an operating space, the method comprising the following steps performed by a processor:
receiving image data, detected by a measurement device and representative of an image including at least one component of the industrial equipment;
processing the image data by machine vision algorithms to identify a control parameter;
processing of the image data and determining a dimensional measurement, by machine vision algorithms, corresponding to the identified control parameter;
formulating and sending a read request to a memory, based on the identified control parameter;
sending an allowable maintenance value, representative of an allowable value of the identified control parameter;
comparing the allowable maintenance value with the dimensional measurement;
generating a diagnosis, based on the comparison between the allowable maintenance value and the dimensional measurement.

2. The method according to claim 1, comprising a step of generating display data, representative of a modified image, including the image received via the image data and one or more geometric features, representative of dimensions and edges of the features identified in the image and a step of loading the display data onto a display unit of a device, to display the modified image in real time.

3. The method according to claim 2, wherein the processor updates the display data as the image data changes, in real time.

4. The method according to claim 1, comprising an interaction step, comprising the following steps:
generating interaction data, representative of one or more selection commands with which a user can interact;
loading the interaction data into a display unit of a device, to enable interaction with the user;
receiving control data, entered by the user based on the selected command, wherein the control data are representative of one or more of the listed steps to be performed by the processor:
saving the image data and/or the dimensional value calculated from the image data;
setting of the number of useful working hours remaining;
request for immediate maintenance intervention;
scheduling a preventive maintenance intervention.

5. The method according to claim 1, wherein the image data is representative of a distance between links of a chain of the industrial equipment, adjacent to each other, and wherein the limit maintenance value includes a limit distance value between two successive links.

6. The method according to claim 1, comprising the following steps:
receiving reference data, identifying a shape, a colour or a outline of a component;
identifying the control parameter based on the reference data.

7. The method according to claim 6, comprising a step of receiving acknowledgement data, entered by a user to confirm or reject a control parameter identification performed by the processor, and wherein the processor updates the reference data based on the acknowledgment data.

8. A device for inspecting an industrial equipment comprising:
a processor, configured to perform the steps of the method according to claim 1;
a memory, including allowable maintenance values;
a display unit, configured to show a diagnosis of the industrial equipment;
one or more selection commands, configured to allow control data to be entered by a maintenance user;
a measurement devices, configured to capture image data, representative of an image including at least one component of the industrial equipment.

9. The device according to claim 8, comprising a wireless connection and configured for transmitting the image data to a remote server, including a remote memory, and wherein the device is a mobile device, wearable by a maintenance user.

10. A computer program including instructions for executing the method according to claim 1, when launched on the device.

11. A system for inspecting an industrial equipment, comprising:
a measurement apparatus including:
an inspection zone, configured to house the industrial equipment at a predetermined inspection location;
a measurement device, configured for detecting measurement data, representative of measurements performed on the industrial equipment, and parameter data, each associated with a corresponding measurement data and representative of a respective parameter of the industrial equipment to which the measurement data relates, the measurement device being a device according to claim 8;
a handling device, configured for moving the measurement device around the industrial equipment;
a memory, including, for each parameter of the industrial equipment, a corresponding limit maintenance value;
a control unit, programmed for receiving the measurement data and the parameter data,
characterised in that the control unit is programmed for:
identifying, for each parameter data, the corresponding parameter of the industrial equipment;
retrieving, for each parameter of the industrial equipment, the corresponding limit maintenance value;
comparing, for each parameter of the industrial equipment, the corresponding limit maintenance value and the corresponding measurement data;
performing a diagnosis of the industrial equipment, based on the comparison, for each parameter of the industrial equipment, between the corresponding limit maintenance value and the corresponding measurement data.

12. The system according to claim 11, wherein the measurement device comprises a two-dimensional video camera or a three-dimensional video camera.

13. The system according to claim 12, wherein the parameter data are image data, detected by the video camera and wherein the control unit is programmed to identify the parameter corresponding to the parameter data based on image recognition algorithms.

14. The system according to claim 11, comprising a remote server, in which is allocated the memory and wherein the control unit comprises a transmission unit and a processing unit, wherein the transmission unit is associated with the measurement device and is configured to send the measurement data and the parameter data to the processing unit, which resides on the remote server.

15. The system according to claim 11, comprising a user interface, including a display, and wherein the control unit is programmed to show diagnosis results on the display, the user interface comprising selection commands, by which the user can confirm or reject the diagnosis.

16. The system according to claim 11, wherein the measurement apparatus comprises a handling device, configured for moving the measurement apparatus inside an operating space in which the industrial equipment is used.

17. The system according to claim 16, wherein the measurement apparatus is a drone, which can be controlled remotely inside the operating space.

18. The system according to claim 11, wherein the measurement device performs a contact measurement.

19. The system according to claim 11, wherein the handling device comprises a robotic arm, movable by translation along three axes perpendicular to each other and rotating about each of said three axes.

20. The system according to claim 11, wherein the parameters of the industrial equipment subject to measurement can be selected from one or more of the following parameters:
wheel diameters;
thickness of the forks;
wear of the chains.

21. The system according to claim 11, wherein the control unit is programmed for:
storing in the memory a log of the measurements, including a set of measurement data of a parameter for a same equipment;
determining, on the basis of the log of the measurements, a rate of wear;
programming, on the basis of the rate of wear, one or more preventive maintenance interventions.

22. A method for inspecting an industrial equipment, the method comprising the following steps:
positioning the industrial equipment at a predetermined inspection location inside an inspection zone of a measurement apparatus;
measuring measurement data, representing dimensional measurements performed on the industrial equipment;
detecting parameter data, each associated with a corresponding measurement data and representing a respective parameter of the industrial equipment to which the measurement data relates;
moving the measurement device around the industrial equipment;
receiving measurement data and parameter data in a control unit;
identifying, for each parameter data, the corresponding parameter of the industrial equipment;
recovering, for each parameter of the industrial equipment, a corresponding limit maintenance value;
comparing, for each parameter of the industrial equipment, between the corresponding limit maintenance value and the corresponding measurement data;
diagnosing the industrial equipment, on the basis of the comparison, for each parameter of the industrial equipment, between the corresponding limit maintenance value and the corresponding measurement data.
